(19) United States
(12) Patent Application Publication
(10) Pub. No.: US 2015/0306808 A1
(43) Pub. Date: Oct. 29, 2015

(54) APPARATUS AND METHOD FOR HEATING PLASTIC PARISONS

(71) Applicant: KRONES AG, Neutraubling (DE)

(72) Inventor: Wolfgang Schoenberger, Brennberg (DE)

(21) Appl. No.: 14/693,682

(22) Filed: Apr. 22, 2015

(30) Foreign Application Priority Data
Apr. 23, 2014 (DE) 10 2014 105 675.2

(51) Int. Cl. B29C 49/64; B29C 49/42; H05B 3/00; B29C 49/08

(52) U.S. Cl. CPC B29C 49/6445; B29C 49/08; B29C 49/4205; H05B 3/0057; B29K 2105/258

(57) ABSTRACT

An apparatus for heating plastic parisons includes a transport device which transports the plastic parisons along a predetermined transport path (T), and with at least one heating device, which is disposed stationary with respect to the transport path of the plastic parisons. The heating device has at least one first radiation source which emits thermal radiation as well as at least one reflector device which reflects at least a proportion of the thermal radiation emitted by the radiation source in the direction of the plastic parisons. The reflector device has a first section with a substantially parabolically curved configuration as well as a second section with a curved configuration, of which the curvature progression differs from the curvature progression of the first section.

The present invention relates to an apparatus and a method for heating plastic parisons. In the prior art it is known that so-called plastic parisons, in particular made of PET, are initially heated in a furnace and then in the context of a blow moulding process, in particular a stretch blow-moulding process, are transformed or expanded into plastic containers. In the currently practised heating of the plastic parisons in heating modules infrared radiators with reflectors positioned behind them are often used (in particular in the form of rib tiles). A targeted and intensive heating of particular regions, in particular a neck region of the plastic parisons, is usually implemented by means of a quartz glass disc positioned between the radiator and the plastic parisons. In this case it is also attempted to separate the main body of the plastic parisons and the mouthpiece region with regard to the impinging infrared radiation. In the subsequent transformation it is usually only the main body which is expanded and the threaded or mouth region is left. In fact with regard to this mouth region it is even desirable that this is not heated significantly, so that it is not destroyed in the subsequent transforming process.

In other words the said two regions have to be kept thermally separate from one another as far as possible, in order on the one hand to achieve targeted heating of the main body of the plastic parisons and in order on the other hand to prevent unwanted heating of the mouth region. Parabolic and elliptical reflectors which can solve this problem are also known from the prior art.

By an approximately spherical or conical spread of the IR beams which is known in the prior art, in spite of the quartz glass discs described above in greater detail a very large proportion of the radiation still reaches the mouth region of the plastic parisons. Even the shielding plate in use nowadays cannot completely prevent this effect. Due to too much heating of the mouthpiece region, as mentioned above, the mouthpiece can be deformed in a subsequent blow moulding process. This superfluous radiation energy or heat unnecessarily provided there must also be cooled down again in a complex manner which is disadvantageous in energy terms, and this can for example take place by means of cooling of the mouth.

Also the known elliptical reflectors cannot completely avoid this negative effect, since although they place the focusing point (i.e. the second focal point of the ellipse) on the first preform wall, and focus the beam exactly, however, this beam is fanned out again in the second preform and thus the mouth is heated again. Pure parabolic reflectors in turn have the disadvantage that they must be designed to be very wide and also focus less than pure elliptical reflectors.

Therefore the object of the present invention is to increase or at least to maintain the efficiency of the heating of the plastic parisons, but also to prevent the occurrence of undesirable heating, in particular in the mouth region of the plastic parisons. Thus the primary object of the invention consists in an improved, targeted and largely influenceable temperature regulation of the plastic parisons, so that the thread region and the support ring thereof is heated only slightly or not at all and preferably the neck region thereof can be heated in the most possible defined manner, in order that the blow moulding process following the heating can be carried out as exactly as possible.

In particular, in order to ensure a neat neck extension, a concentrated strong heating should be carried out below the support ring without thereby heating the mouth too much. This object is achieved according to the invention by the subject matters of the independent claims. Advantageous embodiments and further developments form the subject matter of the sub-claims.

An apparatus according to the invention for heating plastic parisons has a transport device which transports the plastic parisons along a predetermined transport path. Furthermore the apparatus has a heating device which is disposed stationary with respect to the transport path of the plastic parisons, wherein the heating device has at least one first radiation source which emits thermal radiation as well as at least one reflector device which reflects at least a proportion of the thermal radiation emitted by the radiation source in the direction of the plastic parisons.

According to the invention the reflector device has a first section with a substantially parabolically curved profile as well as a second section with a curved configuration, of which the curvature or of which the curvature progression respectively (in particular of which the curvature progression as a function of a longitudinal direction of the plastic parisons to he heated) differs from the curvature or the curvature progression respectively (in particular of which the curvature progression as a function of a longitudinal direction of the plastic parisons to be heated) of the first section.

Preferably the first section of the reflector device is disposed in such a way with respect to the radiation source and/or the plastic parisons or the transport path thereof respectively that radiation components reflected by this first section reach the plastic parisons directly. Preferably the second section of the reflector device is disposed in such a way with respect to the radiation source and/or the plastic parisons or the transport path thereof respectively that at least a proportion of the radiation reflected by this second section does not reach the plastic parisons directly, but is reflected at least one further time and in particular is reflected at least one further time on a region of the first section. In addition, however, it is also possible that at least a proportion of the radiation reflected by this second section reaches the plastic parisons directly.

Thus a specially adapted reflector is proposed which is configured in such a way that, on the one hand, the resulting radiation can be almost completely passed to the main body or the regions below the support ring respectively, but on the other hand radiation is prevented as far as possible from impinging on the thread region. Thus special reflector shapes with the combination of parabolic, possibly elliptical and spherical reflectors as well as the arrangement thereof relative to one another are achieved. By a skilful design of the focal point positions almost a hundred percent of the radiation can be introduced into the main body of the parison.

A substantially parabolic configuration is understood to mean that this does not necessarily have to correspond exactly to a mathematically parabolic configuration, but may deviate therefrom. It is known that a parabola is described by the equation ax²+bx+c. A substantially parabolic configuration is understood to mean that within the parabola slight variations with regard to the factors a and b as well as the summand c of for example up to 15%, preferably up to 10%, preferably up to 5% may occur. Also the parabola does not have to be described exactly by x²; it would also be conceivable that instead of the exponent 2 exponents between 1.9 and 2.1, preferably between 1.95 and 2.05, are used. It would also be possible that the configuration of the curvature is also described by a spline, wherein summands or factors respectively with higher exponents than 2 (for instance x³, x⁴, x⁵ and the like) may also occur (for instance in the manner of an equation f(x)=ax⁵+bx⁴+cx³+dx²+ex+f). However, the configuration should be substantially parabolic. The parabolic configuration described here can preferably be defined as a function of the longitudinal direction of the plastic parisons (or x values of the above equation proceeding in this direction respectively).

Furthermore it is possible that the two sections directly adjoin one another. In addition, however, it would also be possible that between these sections a straight section (in the transport direction of the plastic parisons) is disposed between the first section and the second section.

The transport device advantageously has a plurality of holding devices which hold the plastic containers individually. These holding devices may for example be mandrels which engage in the mouths of the plastic parisons.

In a further advantageous embodiment the transport device also has rotary devices which rotate the plastic parisons about their own longitudinal axis during the heating thereof. In this way it is also possible to substantially maintain the geometric position with respect to the plastic parison and the heating devices and nevertheless to exclude the mouth of the plastic parisons from the heating.

The parabolic configuration advantageously exists in a plane to which the transport path of the plastic parisons is perpendicular. Thus the parabolic configuration is preferably produced in a plane in which the longitudinal direction of the plastic parisons to be heated is located. This parabolic configuration preferably extends along the transport path of the plastic parisons. The radiating devices preferably extend in this transport direction.

The thermal radiation is preferably infrared radiation or radiation which at least contains infrared proportions. The radiation advantageously contains proportions in the near infrared range (NIR) and/or in the far infrared range (FIR).

In a further advantageous embodiment the reflector device has a reflective and in particular highly reflective surface. Thus the reflectors preferably do not have a diffuse action. The surface of the reflector device which reflects the thermal radiation onto the plastic parisons preferably involves polished and or metallic materials which are selected in particular from a group of materials including aluminium, silver, gold, nickel, steel, copper, alloys of these materials and corresponding surface coatings.

By the reflector device thus described it is possible both to keep the thermal radiation away from the mouth region of the plastic parisons and also to introduce heat into regions below the support ring and thus to achieve a concentrated strong heating below the support ring without heating the mouth too much. In addition, advantages in terms of energy are also produced by the targeted introduction of the infrared radiation into the main body of the plastic parison.

In a preferred embodiment the first section is located nearer to a wall of the plastic parison than the second section. Thus if for example the plastic parison is transported upright with the mouth at the top, the first portion is disposed in a vertical direction below of the second section. In other words the second section is preferably also disposed nearer to the thread of the plastic parison. The plastic parisons are preferably transported through a transport line, wherein the heating devices described here are preferably disposed on one side of this transport line. Further reflector devices are preferably also provided and the plastic parisons are transported between the heating devices described here and these further reflector devices. In this way thermal radiation which has passed through the plastic parisons can be reflected again onto the plastic parisons.

In a further advantageous embodiment the transport device is constructed in such a way that it transports the plastic parisons with the mouth at the top. This is indeed disadvantageous in so far as heat produced in the heating device also flows upwards and effects a certain heating of the mouths. However, with opposite interpretation it would be necessary that either the plastic parisons or the subsequently manufactured plastic bottles must be turned round at a later time. Therefore the plastic parisons are preferably vertical when transported, with the mouth at the top. However, the invention does not exclude reversed transport of the parisons, with the mouth directed downwards.

In a further advantageous embodiment the heating device has a second radiation source which is disposed offset with respect to the first radiation source in the longitudinal direction of the plastic parisons to be heated. Thus this second radiation source is located below the first radiation source in the case of stationary transport. Thus this second radiation source also preferably serves for heating of the main body of the plastic parisons, wherein however there is preferably no longer any fear of heating of the mouth region of the plastic parisons by this second radiation source and the radiation from this radiation source already does not reach the regions of the plastic parisons located directly below the support ring.

In a further advantageous embodiment the heating device also has a second reflector device which reflects at least a proportion of the thermal radiation emanating from the second radiation source onto the plastic parison or the plastic parisons respectively. Advantageously the second radiation source is a radiation source which extends along the transport direction of the plastic parisons. Thereby, this second reflector device preferably has differently curved regions by comparison with the first reflector device. Thus for example the second reflector device could be designed as a purely parabolic reflector with only one parabolic curvature.

In a further advantageous embodiment the radiation source is disposed in a focal point of at least one of the two sections of the reflector device. In this way a very precise reflection of the radiation at least from this reflector device onto the plastic parisons can be achieved.

In a further advantageous embodiment the radiation source is also disposed in the focal point of at least one further section of the reflector device or of the other section of the reflector device respectively.

In the drawings it is explained in greater detail how such a radiation source can be disposed, wherein in particular the geometric extension thereof can be taken into consideration.

In a further advantageous embodiment the first section of the reflector device has the configuration of a semiparabola. Thus it has a parabolic structure, which begins at a predetermined point of origin and then extends parabolically in particular in the longitudinal direction of the plastic parison for example in the direction towards the mouth of the plastic parison.

In a further advantageous embodiment the second section also has a substantially parabolically curved configuration. In this case, however, the slope within the second section can preferably differ from the slope of the first section. The first section preferably has a greater slope than the second section. The slope of the first section is preferably at least 1.5 times as high as the slope of the second section, preferably at least 2 times as high and preferably at least 3 times as high.

However it would also be possible that the second section has a non-parabolic configuration, for example an elliptical configuration or a circular configuration. In a further advantageous embodiment the second section also has the configuration of a semiparabola. Thus in this configuration both the first section and also the second section is designed as a semiparabola. In this way the required installation space can be reduced. Thus for example the first semiparabolically designed section (in the case of plastic parisons transported with the mouth at the top) can be constructed partially and preferably completely above the radiation source. Also the second section can extend at least in an upper region of the radiation source or above a geometric centre point of the radiation source.

In addition combinations of these configurations can also be provided in so far as sub-sections are formed which assume partially elliptical and partially circular configurations.

In a further advantageous embodiment the reflector device has a third section of which the curvature progression differs from the curvature progression of the first and second sections. In this case this third section in turn can achieve a targeted penetration of heat in regions directly below the support ring of the plastic parisons.

In a further advantageous embodiment at least one reflector device has an opening through which radiation can exit. To this end it is possible that through this opening radiation impinges on a further reflector device. This opening advantageously extends along the configuration of at least one reflector section. This opening is preferably disposed in such a way that radiation passing through it does not impinge directly on the plastic parison but preferably on a further reflecting section, in particular a further section of the reflector device. Advantageously the said opening is delimited by two sub-sections of the same section of the reflector device. Thus it is possible that the first section extends to a specific point on the reflector device, at this point the opening adjoins and after the opening the first section extends further again.

Furthermore the present invention is directed to a heating device for heating plastic parisons, wherein the heating device has at least one first radiation source which emits thermal radiation as well as at least one reflector device which reflects at least a proportion of the thermal radiation emitted by the first radiation source in the direction of the plastic parisons. Furthermore the heating device has at least one second radiation source which is disposed offset in the longitudinal direction of the parisons with respect to the first radiation source, as well as at least a second reflector device which reflects at least a proportion of the thermal radiation emanating from the second reflector device in the direction of the plastic parisons.

The reflector device preferably has a first section with a substantially parabolically curved configuration as well as a second section with a curved configuration, of which the curvature and/or the curvature progression differs from the curvature and/or the curvature progression of the first section.

Furthermore the reflector device is preferably implemented in the manner described above.

Furthermore the present invention is directed to a method for heating plastic parisons, wherein plastic parisons are transported by means of a transport device along a transport path and are heated by a heating device during this transport. In this case the heating device has at least one first radiation source which emits thermal radiation for heating the plastic parisons as well as at least one reflector device which reflects at least a proportion of the radiation emitted by the first radiation source onto the plastic parisons.

According to the invention the reflector device reflects the thermal radiation at least by means of a first section with a substantially parabolically curved configuration as well as by means of a second section with a curved configuration, of which the curvature or curvature progression differs from the curvature or curvature progression of the first section, onto the plastic parisons.

Therefore in terms of the method it is also proposed that the radiation is reflected by the reflector devices described above. Advantageously the reflector device reflects radiation into regions of the plastic parison which are located in the main body or on the external periphery of the main body of the plastic parison, preferably also into regions which are located immediately below a support ring, but preferably substantially not into regions which are located above the support ring or in the support ring itself.

By the procedures described here a targeted and preferably also influenceable temperature regulation or heating of the plastic parisons can be achieved, wherein in particular the thread regions and support rings are not heated or are only heated a little and on the other hand neck regions located below the support ring can be heated in the most possible defined manner in order thus to be able to carry out as exactly as possible the blowing process which preferably follows the heating process. In fact, in order to ensure a neat neck extension, concentrated strong heating must be carried out below the support ring without thereby heating the mouth too much.

Further advantages and embodiments are apparent from the appended drawings. In the drawings:

FIG. 1 shows an apparatus for heating plastic parisons;

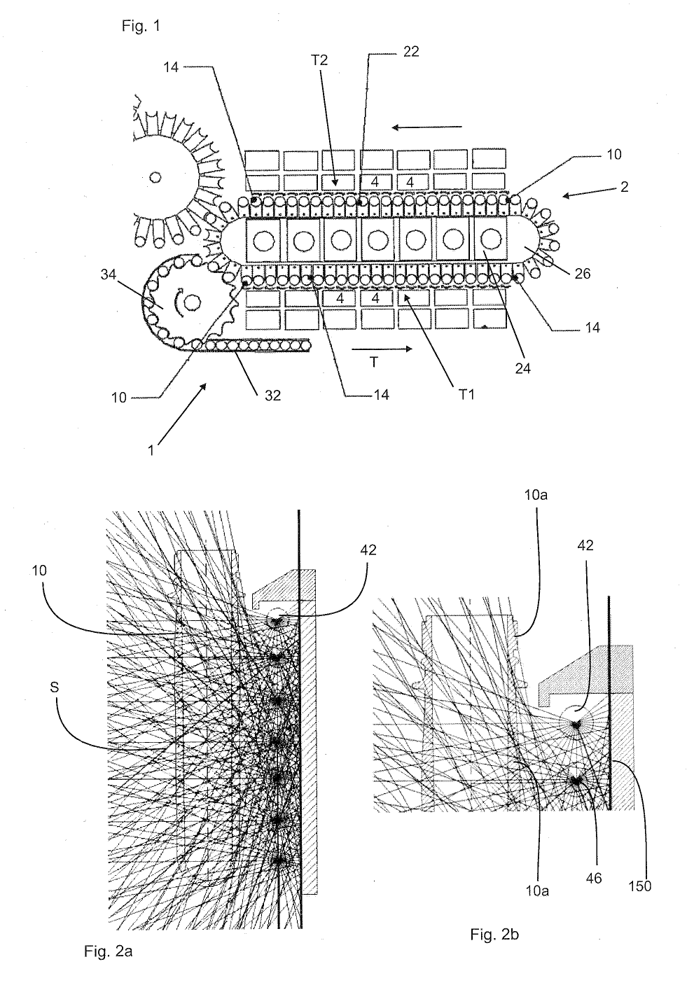

FIG. 2a shows a representation of the heating of the plastic parisons according to the prior art;

FIG. 2b shows a representation of a detail of the heating shown in FIG. 2a;

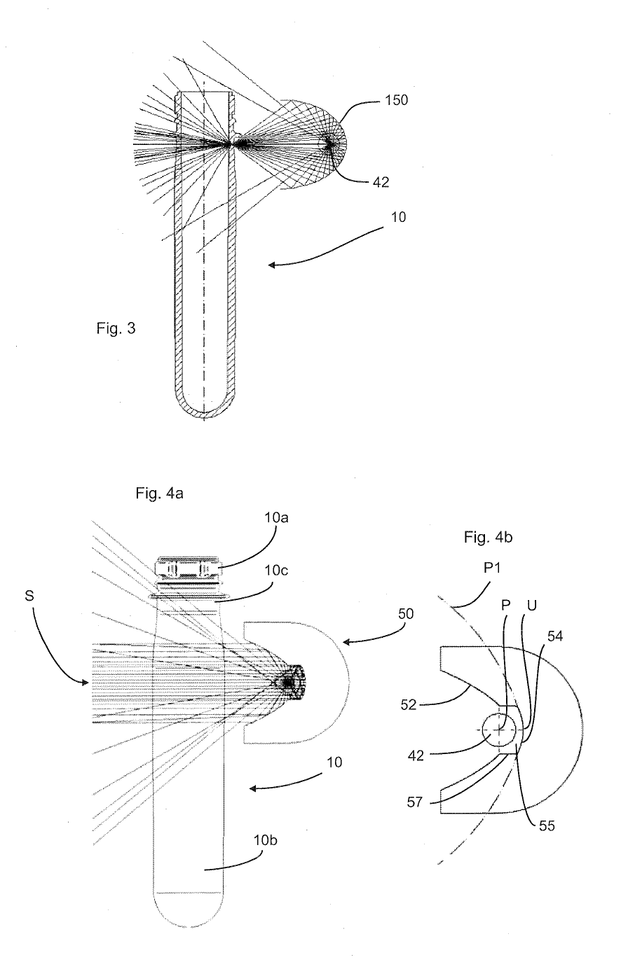

FIG. 3 shows a further representation of heating according to the prior art;

FIG. 4a shows a representation of heating with a reflector device according to the invention;

FIG. 4b shows a representation of a detail of the reflector device shown in FIG. 4a;

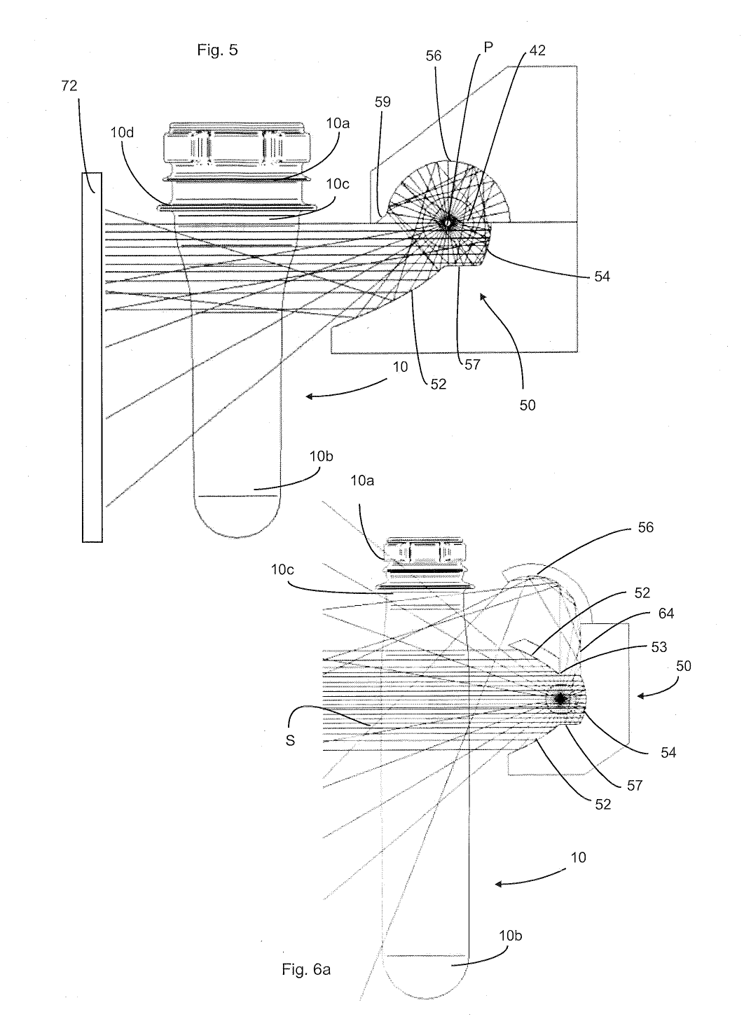

FIG. 5 shows a further embodiment of a reflector device according to the invention;

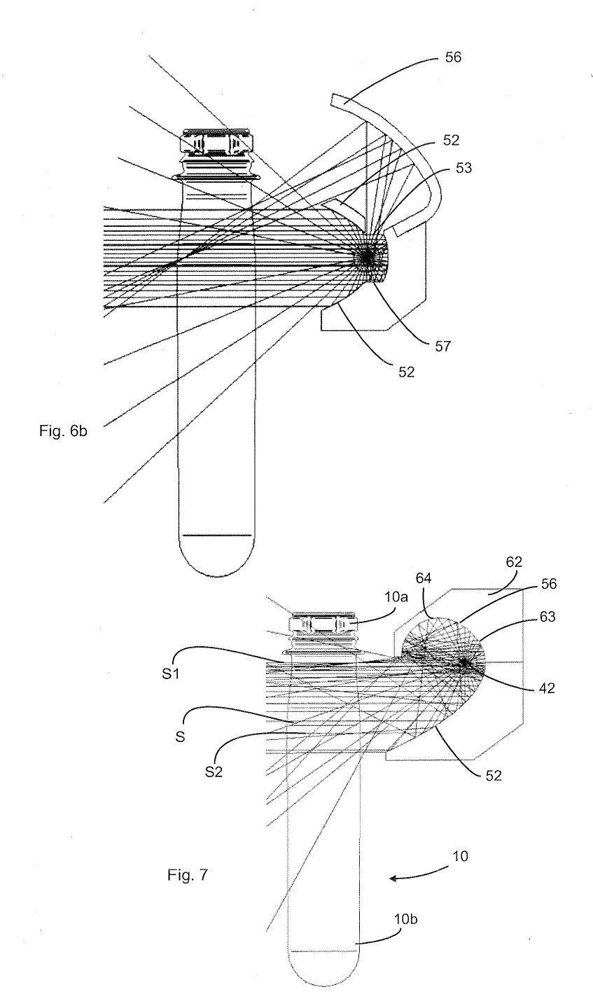

FIGS. 6a, 6b show two further embodiments of a reflector device according to the invention;

FIG. 7 shows a further embodiment of a reflector device according to the invention;

FIG. 8 shows a representation of the reflector device shown in FIG. 7 in a heating device; and

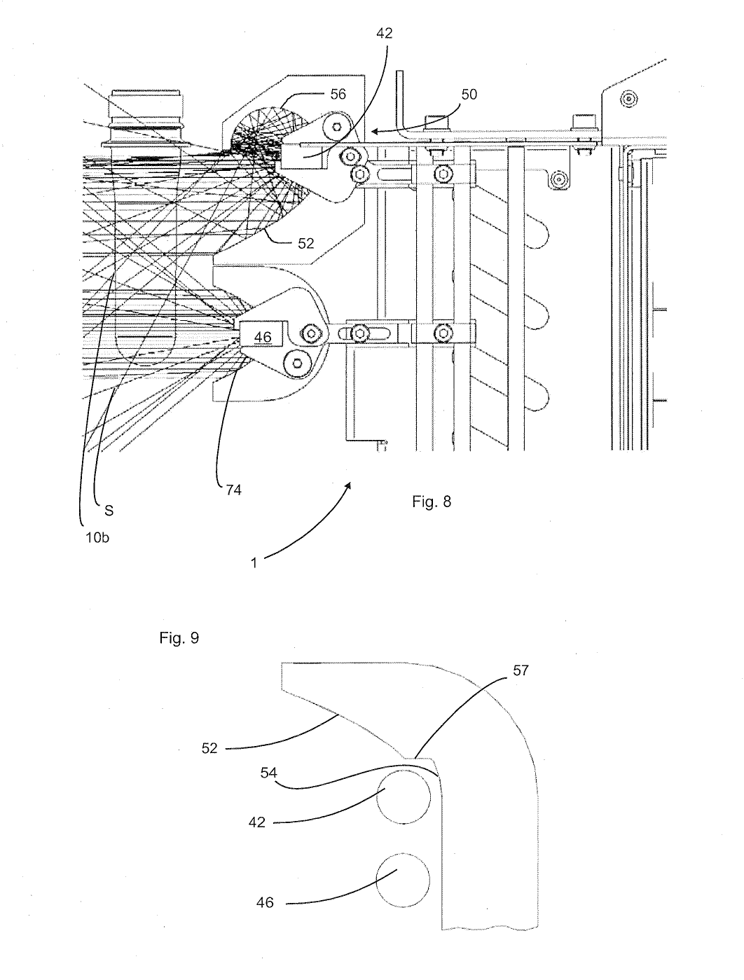

FIG. 9 shows a further very preferred embodiment of a reflector device.

FIG. 1 shows a schematic representation of an apparatus 1 according to the invention. In this case plastic parisons 10 are delivered by means of a delivery device 32 initially to a separating device 34, such as in particular, but not exclusively, a sawtooth star and are separated there. Then the plastic parisons 10 separated in this way are transferred to the actual heating device, i.e. the apparatus 1, and in this case are transported to a plurality of holding devices 14. These holding devices 14 may, as mentioned above, be or have mandrels which engage in the mouths of the plastic parisons 10.

The reference signs 4 relate in each case to heating devices which are disposed along the transport path T or of which the partial paths respectively laterally with respect to the plastic parisons thus conveyed. The reference sign 22 designates roughly schematically a rotary device which effects a rotation of the plastic parisons 10 about its own longitudinal axis.

The reference sign 2 relates as a whole to a transport device which conveys the plastic parisons on a transport path T or on the partial paths T1 and T2 respectively. The reference sign 26 designates a deflecting device, such as a deflecting wheel, around which the plastic parisons 10 are guided. Therefore as a whole the plastic parisons are transported section by section along straight paths.

FIGS. 2a and 2b show two reflector devices according to the prior art. These reflector devices have a straight section 150 (see FIG. 2b). Thus a plurality of radiation devices or radiation sources 42 respectively are provided as well as reflectors which are located behind them. It can be seen in the representations of FIG. 2a and FIG. 2b that the majority of the radiation S is radiated past the main body of the plastic parison and also into the mouth and into the base region and thus is lost.

For this reason parabolic reflectors are likewise used in the prior art. However, these simple parabolic reflectors used according to the prior art have the disadvantage that the parabolic shield or the reflector respectively has to be drawn very far over the actual radiator or the radiation device respectively in order to collect the radiation and to reflect and direct it forwards.

In this way, however, the height is very great (due to the width the parabola), which then only allows a small number of radiators and thus lowers the energy density. Furthermore elliptical reflectors which focus the radiation in the second focal point of the ellipse (cf. FIG. 3) are known from the prior art. In this way the radiation can be focused very well on a point. This point is mostly directed onto the first preform wall. However, it appears disadvantageous here that as they pass through the second preform wall the beams fan out again and in this way the support ring of the mouth is undesirably heated particularly strongly.

FIGS. 4a and 4b show a first embodiment of a reflector device 50 according to the invention. It will be seen that the beams S are directed well onto the main body 10b of the plastic parison and only a small amount of radiation impinges on the mouth region 10a of the plastic parison.

FIG. 4b shows a representation of a detail of the reflector device shown in FIG. 4a. A first section 52 can be seen here which is of parabolic construction and also a second section 54, which is likewise of parabolic construction but has a lesser parabola slope. However, these two combined parabola have the same focal point P, in which the radiation device or radiation source 42 respectively is disposed. The reference sign 55 designates a recess with respect to the first section 52 into which the radiation device 42 is partially sunk. In this way the actual extent of the radiation device can be taken into account. Thus two combined parabola are illustrated here with one and the same focal point position.

The advantage over a simple parabola or a parabolic internal reflector here is that in a very narrow embodiment the radiation can be guided with a good energy density in the direction of the main body of the plastic parison. The broken line P1 shows the theoretical parabola configuration of the second section 54. The reference sign 57 designates a wall portion which extends between the two sections 52 and 54 and which thus preferably extends perpendicular to a plane which is enclosed by the transport direction of the plastic parisons and the longitudinal direction thereof. Also this wall portion preferably consists of a reflective material.

FIG. 5 shows a further embodiment of a reflector device according to the invention. In this embodiment the first parabolic section 52 is likewise combined with the second parabolic section 54 here, as also shown in FIG. 4b. However, only semiparabolas are shown here. The reference sign 57 again designates the step between the two parabolic sections, which is also present in the embodiment shown in FIG. 4b. The height of this step is obtained from the slopes of the two parabolas or the co-ordinates based on calculations respectively in the X section or the longitudinal section respectively of the plastic parison in the region of the step 57, so that the focal points of both sections coincide.

Furthermore the embodiment shown in FIG. 5 has a third section 56 which has a spherical surface or structure respectively here. More precisely, the third section here is of hemispherical design. In addition at the end of this reflector a stepped section 59 is provided which extends at an angle between 30° and 60° with respect to an imaginary tangent to the spherical section. The beams which are reflected on the wall of the section 56 can be reflected again by the radiation device 42 or the filament thereof respectively and thus are reflected on the first section 52, from where they reach the plastic parisons 10.

The reference sign 72 relates to a further reflector which is disposed behind the plastic parisons 10 relative to the reflector device 50. This further reflector 72 reflects radiation which passes through the plastic parisons back again onto these parisons.

The advantage of this combination of the two parabolic sections with a spherical mirror, of which the centre is preferably located precisely in the focal point position P of the two parabolas, is that hereby the radiator field can be narrowed by half and at the same time the energy density of the radiation is approximately doubled. The radiation is reflected back again to the centre point of the radiator by the spherical mirror or the spherical reflector at the top here. A majority of the radiation here goes through the radiation device 42 (in particular through the filament thereof) and thus arrives at the parabolic reflector 52 which directs the radiation forwards onto the plastic parison. The region 10c which is located below the support ring 10b of the plastic parison can also be favourably heated by this procedure.

FIGS. 6a and 6b show further embodiments with a reflector device 50. A first section 52 and a second section 54 which in each case are parabolically configured are likewise provided in this embodiment. Additionally, however, the first section has an opening or gap respectively through which radiation can reach a third section 56 and in the embodiment according to FIG. 6a it can also reach a straight section 64. A disadvantage of the combinations of two or more parabolas (family of parabolas) shown in the above embodiments is that the focal point position must always be identical in order to direct the radiation forwards (i.e. onto the plastic parisons).

For this reason the points of origin of the combined parabolas are always positioned offset with respect to one another, which means that the parabolas do not intersect one another. However, in order to connect the parabolas sensibly to one another, a straight line is advantageous which does not bring radiation in the direction of the plastic parison (i.e. the section 57). This proportion of the radiation would be destroyed in the reflector. However, in order also to be able to use this proportion in terms of energy, openings or elongate holes 53 have been incorporated here in the trough-shaped reflector or the section 52 respectively.

As a result the internal and external reflector (external reflectors 56, 64) can be connected to one another and simultaneously the radiation which is otherwise lost radiation can pass through the elongate hole and impinge on the externally located reflector section 56 and likewise on the plastic parisons 10. Whereas in the embodiment shown in FIG. 6A the third section 56 is of spherical construction, in the representation shown in FIG. 6B this section 56 is of elliptical construction. However, it would also be possible that this third section 56 is likewise of parabolic construction.

FIG. 7 shows a further embodiment which combines all three components, spherical mirror reflector (section 64), elliptical reflector (section 56) and also parabolic reflector (section 52) together in an ideal manner. In this embodiment the reflector device is advantageously constructed in two parts. The upper part 62 here is advantageously equipped as a cooling shield and at the same time operates as a focusing reflector. By means of the elliptical section 63 of the reflector device the radiation is concentrated in the first wall of the plastic parison. This then goes (cf. reference sign S1) downwards in the direction of the main body of the plastic parison through the second wall of the plastic parison and not through the support ring or into the mouth 10a.

The proportion of the radiation which is produced by a simple open elliptical reflector (section 56) is directed by means of a spherical mirror section 64 (in the upper left region) through the radiation device 42 again onto the side of the parabola or the first section 52 respectively. The parabolic section 52 is again located in the lower part of the two-part reflector device and this now directs the radiation density increased by the spherical mirror directly to the wall of the plastic parison, as shown by the proportion of the radiation S2. Preferably in this case the respective centre points or focal point positions respectively of the individual reflector sections or the sections 52, 56 and 64 respectively with the centre point of the radiation device 42 lie geometrically at the same point or on the same line respectively, which preferably extends along the transport path of the plastic parisons.

With this design it is possible to guide virtually 100% of the generated radiation onto the main body 10b of the plastic parison 10. In addition, with a very small and favourable overall size of the reflector device it is possible to place radiation with high local uniformity directly under the support ring. This can also take place without disadvantageously heating the mouth region 10a.

FIG. 8 shows an installation situation of the reflector device 50 according to FIG. 7 in a heating device 1. In this case a second radiation device 46 is disposed below the first radiation device 42 which, here, is disposed inside a parabolic mirror 74. However, the portions of the radiation which exit obliquely at the top likewise also impinge on the main body 10b of the plastic parison. In this way it would also be possible for example to combine the embodiments shown above with one another. Thus for example the embodiment shown in FIG. 7 can be combined with the embodiment shown in FIG. 2b, wherein the first-mentioned embodiment heats the neck region of the plastic parison and the embodiment shown in FIG. 2b heats the tip region of the plastic parison.

In addition, however, the other embodiments shown in the drawings can also be combined with one another, wherein a combination of the embodiment shown in FIG. 7 with the embodiment shown in FIG. 3 or a combination of the embodiment shown in FIG. 4 with the embodiment shown in FIG. 2B is referred to here only by way of example. In addition it would be possible for a plurality of the heating devices or reflector devices respectively described here, which may also have different configurations from one another, to be disposed along the transport path, in order to achieve a different profiling of the heating along the transport path of the plastic parisons. Also an individual reflector device can have a changing surface profile along the transport path of the plastic parisons.

In addition the heating device can also have a shielding element, which keeps thermal radiation away from the plastic parisons 10, for instance in the form of the quartz glass disc or a shielding plate described in the introduction.

Additionally by a suitable arrangement of the radiation devices a uniformly heated plastic parison can be profiled exactly and in the shortest possible time at the end of a heating process. This means that specific regions of the plastic parison can be more strongly heated than others, in order to expand these in a subsequent stretch blow moulding process. If the beam paths of the above illustrations are compared with the beam paths from the prior art, it appears unambiguous that both the profiling and also the behaviour in terms of energy can be significantly improved. Thus in particular an improved neck extension is possible in the event of concentrated strong heating, in particular below the support ring, without heating the mouth region 10a of the plastic parisons too much. In addition advantages in terms of energy are also produced by the targeted introduction of the infrared radiation into the main body of the plastic parisons.

FIG. 9 shows a further very preferred embodiment of a reflector device. In this configuration both the first section and also the second section are each designed as semiparabolas. The first section 52 here is disposed above the radiation device 42. However, the first section 52 could also be disposed (at least partially) below the first radiation device 42. In addition a step 57 which extends perpendicular to the longitudinal direction of the plastic parisons is again disposed between the two sections 52 and 54. It will be recognised that the parabola slope of the second section 54 is substantially smaller than the parabola slope of the first section. Here the vertex of the second section is preferably located at the height of a geometric centre point of the radiation device.

The applicant reserves the right to claim all the features disclosed in the application documents as essential to the invention in so far as they are individually or in combination novel over the prior art.

### LIST OF REFERENCE SIGNS

1 apparatus, heating device

2 transport device

4 heating devices

10 plastic parisons

10a mouth region

10b main body

10c region below the support ring

14 holding devices

22 rotary device

26 deflecting device

32 delivery device

34 separating device

42 first radiation device/radiation source

46 second radiation device

50 reflector device

52 first section

53 elongate holes

54 second section

55 recess/step

56 third section/external reflector

57 step

59 stepped section

62 upper part

63 elliptical proportion

64 straight section/external reflector/spherical mirror section

72 further reflector

74 parabolic mirror

150 straight section

T transport path

T1, T2 partial paths

S radiation

S1, S2 proportion of the radiation

P focal point

P1 broken line

U point

1. An apparatus for heating plastic parisons comprising a transport device which transports the plastic parisons along a predetermined transport path (T), and at least one heating device, which is disposed stationary with respect to the transport path of the plastic parisons, wherein the heating device has at least one first radiation source which emits thermal radiation as well as at least one reflector device which reflects at least a proportion of the thermal radiation emitted by the radiation source in the direction of the plastic parisons, wherein the reflector device has a first section with a substantially parabolically curved configuration as well as a second section with a curved configuration, of which the curvature progression differs from the curvature progression of the first section.

2. The apparatus according to claim 1, wherein the first section is disposed nearer to a wall of the plastic parisons than the second section.

3. The apparatus according to claim 1, wherein the transport device is constructed in such a way that it transports the plastic parisons with the mouth at the top.

4. The apparatus according to claim 1, wherein the heating device has a second radiation source which is disposed offset with respect to the first radiation source in the longitudinal direction of the plastic parisons to be heated.

5. The apparatus according to claim 4, wherein the heating device also has a second reflector device which reflects at least a proportion of the thermal radiation emanating from the second radiation source onto the plastic parisons.

6. The apparatus according to claim 1, wherein the radiation source is disposed in a focal point of at least one of the two sections of the reflector device.

7. The apparatus according to claim 6, wherein the radiation source is also disposed in the focal point of the other of the two sections.

8. The apparatus according to claim 1, wherein the first section has the configuration of a semiparabola.

9. The apparatus according to claim 1, wherein also the second section has the configuration of a semiparabola.

10. The apparatus according to claim 1, wherein the second section also has a parabolically curved configuration.

11. The apparatus according to claim 1, wherein the reflector device has a third section of which the curvature progression differs from the curvature progressions of the first and second sections.

12. A heating device for heating plastic parisons, wherein the heating device has at least one first radiation source which emits thermal radiation as well as at least one reflector device which reflects at least a proportion of the thermal radiation emitted by the first radiation source in the direction of the plastic parisons, and wherein the heating device has at least one second radiation source which is disposed offset with respect to the first radiation source, as well as a second reflector device which reflects at least a proportion of the thermal radiation emanating from the second reflector device in the direction of the plastic parisons, wherein the reflector device has a first section with a substantially parabolically curved configuration as well as a second section with a curved configuration, of which the curvature progression differs from the curvature progression of the first section.

13. A method for heating plastic parisons, wherein plastic parisons are transported by a transport device along a transport path and are heated by a heating device during this transport, wherein the heating device has at least one first radiation source which emits thermal radiation for heating the plastic parisons as well as at least one reflector device which reflects at least a proportion of the radiation emitted by the first radiation source onto the plastic parisons, wherein the reflector device reflects the thermal radiation of at least one first section with a substantially parabolically curved configuration, as well as a second section with a curved configuration, of which the curvature progression differs from the curvature progression of the first section, onto the plastic parisons.
